(19) United States
(12) Patent Application Publication
(10) Pub. No.: US 2006/0144048 A1
(43) Pub. Date: Jul. 6, 2006

(54) Method and device for converting heat into mechanical or electrical power

(76) Inventor: Detlef Schulz, Leipzig (DE)

Correspondence Address: WILLIAM COLLARD;COLLARD & ROE, P.C., 1077 NORTHERN BOULEVARD, ROSLYN, NY, 11576, US

(21) Appl. No.: 10/563,722

(22) PCT Filed: Jul. 7, 2004
(86) PCT No.: PCT/EP04/07424

§ 371 Date: Jan. 6, 2006

(30) Foreign Application Priority Data
Jul. 7, 2003 (DE) 103 30 574.2

(51) Int. Cl. F03G 6/00

(52) U.S. Cl. 60/641.8

(57) ABSTRACT

The invention relates to thermal energy converters and a method for increasing the efficiency thereof. Said method is based on thermodynamic phase transformation of some solid materials within a very narrow temperature range, e.g. the shape memory effect (SME) or the magnetocaloric effect (MCE). According to the invention, a gradient-type shift of the transformation temperature is set in a fixed manner along the axis of thermal flow by modifying the material properties, and the partial segments having a higher transformation temperature are arranged on the hot side while the partial segments having a lower transformation temperature are arranged on the cold side, said arrangement being as linear as possible or finely graduated. The greater the ratio is between the range of operating temperatures and transformation hysteresis, the easier it is to increase efficiency compared to gas circulation processes by recovering heat between the individual segments as a result of thermal oscillations in the area of material-related hysteresis. Water pumps can be operated with the aid of solar power or lost cooling heat by using serially disposed tube segments (1a-1f) made of slightly different NiTi (nitinol)-based SME metal alloys. Changes in the magnetic flow can be excited and be utilized for inducing electrical power proportionate to the thermal flow in stacked layers made of ferromagnetic alloys (e.g. MnFeAsP).

Heat transformation into mechanical or electrical energy is of enormous economic significance. Notably in the 10-100° C. temperature spread there is often hot water available from cooling processes or solar radiation with different than ambient temperatures.

It is known that transformation of heat into mechanical energy or electric power is limited by the Carnot efficiency that is considered as theoretical limit for all cyclic thermodynamic processes. On principle, only the energy difference between intrinsic energy in a “higher-energy” state Uₕ (prior to energy emission) and intrinsic energy in a “lower-energy” state U_{c} (after energy emission) can be used as effective work W from an energy resource. W=Uₕ−U_{c} and efficiency ·=1−U_{c}/Uₕ. This intrinsic energy U is equivalent to the quantity of heat Q accumulated in the energy resource as temperature and atomic binding energy (latent heat). Thus, also W=Qₕ−Q_{c}, is valid.

There are different methods to transform heat into force or electric power.

To date, thermoelectric energy transformation (Seebeck effect) has only yielded a low efficiency that, due to its principle, is markedly lower than the Carnot efficiency and basically has remained restricted to sensory applications.

Thermovoltaics is based on heating of a “black radiator” (e.g. with broad-band solar radiation, hot gases or long-wave secondary IR) and usage of the latter as an emitter in combination with reflecting filters for a narrow-band IR radiation spectrum that is matched (due to the underlying principle) to the narrow-band efficiency range of a photovoltaic cell. Radiator materials that are doped with rare earths facilitate a narrow-band re-radiation. Practically, current TPV generators achieve an efficiency of some 10%, yet at an emitter temperature of 1500° C.

Thermionic generators generate free electrons by vacuum-annealing of electrodes with typically required temperature differences >1000° C. Efficiencies of up to 20% have been attained at tungsten test electrodes. Recent reports feature new materials and “thermal diodes” in thin-layer technology that yield efficiencies around 20% in electric power generation from waste heat at 200-400° C.

The efficiency of thermo- and photoelectrical methods is restricted, inter alia, by recombination of released electrons still in the active semiconductor layer that is enhanced with temperature increase.

Magneto-hydrodynamic energy transformation (MHD process) is the direct transformation of kinetic energy in flowing, conductive fluids into electrical energy. Segmented Faraday generators and Hall generators with ionised gases or liquid metal are technical MHD applications in power stations, in particular for high-temperature applications. The maximally attainable Carnot efficiency is limited by the employed fluid's conductivity and viscosity.

Thermodynamic energy converters with cyclic gas processes have become most widely distributed. Common combined power and heat processes in their variants, such as Carnot, Otto, Diesel, Stirling, Joule/Brayton, Ericson, Rankine or Kalina cyclic processes, have the known characteristics that a heat carrier fluid, e.g. gases or gas-liquid mixtures, are employed to perform temperature and/or pressure changes. Mechanical energy can be taken off from the existing heat flow. Mechanical efficiency rises with increasing temperature difference, albeit that efficiency cannot effectively rise above 60% due to material-conditions restrictions, even when phase transitions between fluids and gases are exploited. During gas expansion the introduced heat can only be fully transformed into mechanical work only in free space (e.g. explosion in an outer-space vacuum), while in reversible processes the known efficiency restriction of the Carnot cyclic process comes to bear due the compression stroke and compressibility of the working medium. A considerable part of the input heat again arises as waste heat at a lower temperature level and only a portion can be converted into mechanical work. This is countered in the meantime by so-called superheaters in heat pumps that are capable of slightly raising heat transmission and mechanical efficiency.

In case of small temperature differences of below 100 K to ambiance, e.g. waste heat of technical plants (Cooling water 30-95° C.), solar collectors or geothermal springs, low-temperature Stirling motors, e.g., can at best achieve an efficiency of ca. 26% . The low energy storage capacity of the working medium (gas) requires very large volumes for economically feasible energy quantities which makes this method uneconomical for smaller temperature differences.

Memory metals, such as certain nickel-titanium alloys (nitinol) or also copper-aluminium-beryllium (CuAlBe) and copper-aluminium-nickel alloys (CuAlNi) have a known marked property for form change upon heating, the so-called Shape Memory effect (SME).

This effect is based on phase transformation between martensitic and austenitic metal lattice structure. When the material is mechanically deformed below transformation temperature with a comparably small power it returns to its initial form upon heating above transformation temperature in the moment of structural change with a release of higher forces. This force-displacement difference can be drawn off as mechanical work with an occurring entropy change.

A “training effect” can be adopted to even produce so-called 2-way SME that return to their initial form not only upon heating but also upon cooling without any or with only a very small impact of external force and can even perform work, i.e. can oscillate between a “hot form” and a “cold form” by mere temperature fluctuations within the range of lower (M_{f}) and upper (A_{f}) transformation temperatures.

This phase transformation occurs in the limited temperature spread between martensitic lattice structure M_{f} and austenitic structure A_{f} (=upper temperature limit), with a material-depending hysteresis (temperature shift) during back transformation, which is for nitinol typically in the range from 20-30 K, while below 15 K have already been realised.

Since the discovery of SME in 1932 (AuCd) and the early 1960s (NiTi) several Carnot heat-power machines have been built, e.g. with SME muscle wire and SME springs, in which SME elements were alternately immersed in hot and cold water or subjected to air cooling.

It was found that the attainable Carnot efficiency was only 4-9%. The cause of this even poorer efficiency is that a considerable amount of heat is “buffered” in SME material as internal energy (molecular kinetic energy—and has to be dissipated) and “internal friction heat” is generated that cannot be mechanically used during phase transformation. Further causes were constructive heat losses due to passive construction elements and radiant emittance. The mechanical efficiency can be slightly improved by align of the metal structure and optimal power admission to the superelastic structure deformation and decrease of internal structure distortions (internal friction impacts hysteresis). However, the “optimal” efficiency of such Carnot process will not be higher than 9-12% because the buffered thermal energy of metal atoms is emitted unused in the next cooling cycle.

Also under consideration of manufacturing costs, they could not prevail to date over other Carnot cyclic processes, such Otto, Diesel, Stirling motors and Kalina turbine units.

On account of the special memory-metal principle, optimal efficiency in energetic uses of SME metal alloys means that temperature change should occur, if possible, only within the narrow range of phase transformation and when the SME material has the lowest possible hysteresis. In contrast to the above-mentioned thermodynamic cyclic processes, MHD, thermovoltaic and thermoionic processes, a further temperature difference beyond the transformation range in a certain point in a memory-metal material during SME phase transformation does not bring about an efficiency improvement but a deterioration because the heat capacity of the metal conditions more heat to be “buffered” while the portion of mechanical energy that can be taken off has remained the same.

The magneto-caloric effect is based on the fact that ferromagnetic materials, such as the metals iron, nickel, cobalt, gadolinium, terbium and metal alloys such as Monel (Cu—Ni), iron-manganese alloys or oxides such as europium oxide change upon exceeding a material specific temperature—the Curie temperature—from a ferromagnetic state into a paramagnetic state with an entropy change (shown in a change of their heat storage capacity). Upon exposure to a magnetic field the material will slightly heat up. If this heat is dissipated just above the Curie temperature and then the magnetic field removed, a cooling effect occurs. This phenomenon can be used for a cyclic process. heat flow changes can generate magnetic flow changes (magnetisation and demagnetisation) and thus, by induction (e.g. in coils), directly electrical power. The basic cycle is as follows:
1. Magnetisation in cooled-off state below Curie temperature, e.g. with a permanent magnet, at simultaneous further external cooling. During this process, mechanical energy (the attraction of the magnet shortens the displacement of the ferromagnetic working medium and the magnetic flow density increases) or electrical energy can be withdrawn (the magnetic field can be used to induce electrical voltage in a coil). Following this energy withdrawal the ferromagnetic working medium is magnetised and slightly heated up by the MCE. This heat has to be dissipated as fast as possible from the working medium, otherwise the magnetic moment is reduced when the Curie temperature is reached.
2. Heat input following completed Load withdrawal via the Curie temperature. The magnetic flow density in the working medium decreases.
3. Demagnetisation in heated-up state above Curie temperature, e.g. by removing the permanent magnet, at simultaneous further heat input. This process requires only a small amount of mechanical energy because the working medium is no longer ferromagnetic and has hardly any attraction to the magnet). Upon reduction of the magnetic field the MCE effects cooling in the material. This internal cooling effect conditions a faster compensation of such quantity of heat that corresponds to the sum of previously withdrawn collectible energy (mechanical/electrical) plus the heat dissipated in step 1.
4. Further external cooling of the working medium below Curie temperature. The working medium becomes ferromagnetic again but remains demagnetised. Step 1 is repeated.

The heat flow in the working medium and the heat transmission to the atmosphere as well as the ratio of specific heat capacity (non-usable latent heat) and entropy change (MCE in the Curie temperature spread) are limiting the Carnot efficiency.

Also here the same applies as for the SME effect, namely that magnetic or electrical efficiency in a thoroughly uniform material block is limited by non-used latent heat in a thermodynamic cyclic process because entropy change is in an order of only 5-8% of the alloy's specific heat capacity. Again and in contrast to other thermodynamic processes, the increase of the temperature difference between cold and hot side beyond hysteresis limits does not improve but rather deteriorate the efficiency.

Developments based on the metal gadolinium use the magneto-caloric effect for cooling (refrigerator without compressor), where also for the above-mentioned reason only a limited temperature difference can be achieved that is proportional to the amount of entropy change ∩S to the overall entropy in the magnetised hot state. Confer U.S. Pat. No. 03,841,107, U.S. Pat. No. 3,393,526, U.S. Pat. No. 04,107,935, U.S. Pat. No. 4,408,463 (layers), U.S. Pat. No. 04,457,135, U.S. Pat. No. 4,464,903, U.S. Pat. No. 04,704,871 and WO 01/20233 A1. There already marked efficiency enhancements were found as compared to gas-compression cooling units. The working medium is not compressible hence the inevitable input losses in cyclic gas processes are absent and, above all, a considerable size reduction of the employed apparatuses can be attained.

MCE-heat electric power generators and transformers are also described in DE3815500, EP0308611, DE3732312, although they assert to be capable of simultaneously generating electric power and cold only from ambient heat which appears to be dubious in view of the 2nd main theorem of thermodynamics.

The invention is focused on the problem of developing a thermal energy transformer that is characterised by a high efficiency, in particular in a temperature spread from 0° C. to 120° C., in order to convert heat into mechanical or electrical energy.

The objective is enhancing mechanical efficiency in heat-power transformation in contrast to conventional thermodynamic processes, in particular for an efficient usage of small temperature differences.

The problem is solved as described below:

Taking an initial look at the theoretical bases, the energy yield of a heat-power machine and thus the cost-determining machine size can be basically influenced via the temperature spread and as follows:
1. Change of working medium with higher energy density (more stored internal energy per mass or volume unit)
2. Improved heat flow and heat transmission energy transport per unit of time)
3. Reduction of other losses (by friction, radiant emittance, cooling, etc.)
4. Usage of molecular linkage forces in the form of phase transformation or chemical reactions of the energy resource in the temperature spread of the operating range in order to counter the otherwise deteriorating heat transmission by heating of the working medium.

Temperature is not equivalent to thermal energy and also not always proportional to the former. In first order phase transitions, as represented by state of aggregation changes (melting, evaporation), there is a buffering in the form of internal energy (latent heat) that is shown by the typical temperature plateau. Despite energy input or output the temperature remains constant until phase transformation has been fully completed.

Temperature-depending phase transformation have an interesting energy potential, especially entropy anisotropies in second order phase transitions, such as transformation from ferromagnetic to paramagnetic state of some metals (magneto-caloric effect), transformation from martensitic to austenitic metal lattice state (Shape Memory Effect) or also transformation from normal conductive to super-conductive state (super-conductor).

The solution approach for the method according to the invention is based on the second order phase transformation of some solid materials. These are, characterised in that transformation of thermal energy into mechanical (SME) or magnetic or electrical energy (MCE) occurs only within a narrow temperature spread and that, in contrast to other thermodynamic processes (e.g. with gases), there is no proportional dependency of efficiency from the available temperature difference following the firm adjustment of the material-specific transformation temperature. There is no change in the state of aggregation but an entropy change without essential changes in volume and pressure. There is no temperature plateau as in first order phase transformation (state of aggregation changes).

According to the invention the employed working medium of heat-power machine is not gas but a metal alloy in which the second order phase transformation is used for energy conversion. Preferable heat transport fluids are water or an aqueous solution.

The heat transmission of turbulently flowing water to metal or of steam condensing on metal is considerably better than in cyclic gas processes (gas-metal). But also gases and supercritical fluids can be employed. Descriptions of conventional thermodynamic methods frequently give the entropy calculation with the following formula:

$$S ( p , V , T ) = {\int }_{{p}_{0} , {V}_{0} , {T}_{0}}^{p , V , T} {( \frac{ⅆ Q}{T} )}_{rev} + {S}_{0}$$

Pressure, volume and temperature are influencing variables of internal energy. This formula is, however, incomplete because also magnetism is an influencing variable of entropy, at least in ferromagnetic substances (confer the magneto-caloric effect). Thus, the Maxwell equation determines the relation of entropy to the magnetic moment as a function of temperature and magnetic field intensity:

$$Δ {S}_{m} = {\int }_{D}^{H} {( \frac{\partial M}{\partial T} )}_{H} ⅆ H .$$

Second order phase transformation condition changes of electromagnetic (!) forces in the atomic metal lattice structure of the working medium. During the magneto-caloric effect (MCE) magnetic conductivity (magnetic permeability) changes dramatically, during transformation to super-conductivity it is the electrical conductivity and during the shape-memory effect (SME) it is the geometrical form with a release of forces.

The key decisive aspect is that the influencing variables pressure and volume of the working medium remain constant in the process and also the temperature spread of the phase transformation is very narrow. The MCE, e.g., has the below relation:

$${( \frac{\partial S}{\partial H} )}_{T} = {( \frac{\partial M}{\partial T} )}_{H}$$

At a constant temperature the entropy change is proportional to the magnetic field change as at a constant magnetic field the magnetic moment is proportional to temperature. In the working medium metal the other influencing variables of entropy (pressure change, volume change) are negligibly small (like in other second order phase transformation). This is the basis for the direct conversion of temperature changes into magnetic field changes that can be used for induction von electric power or for a motor drive.

When the usage of latent heat stored in the MCE-metal can also be achieved for phase transformation then these temperature changes can be nearly completely converted into magnetic moment changes. When mechanical work is performed or electrical energy induced in this process the resulting cooling effect with energy withdrawal (under ideal full-load conditions) can be largely equated and thus, on principle, an efficiency near the theoretical maximum can be achieved, as is also known of electrical machines or fuel cells. Now there surely is no “ideal full load” and friction losses, etc.; but efficiency is also not impaired by “compression strokes” or “recombination losses” as in other methods.

What may initially appear as a disadvantage for the efficiency in memory-metals and the magneto-caloric effect, namely an efficiency deterioration with increasing temperature difference, may lead, however, by multiple use of the transformation effect in the form of a thermal series connection and in combination with heat recovery to a marked efficiency improvement comes increasingly close to the theoretical maximum with increasing temperature difference and number of steps.

The resulting efficiency can be improved by a series connection of such phase transformation along the heat flow direction, superimposed by alternating heat transfer (thermal vibration with directed heat flow). In order to achieve this, a gradient-like shift of the transformation temperature is firmly adjusted by targeted modification of material properties of the material to be phase-converted along the heat flow axis and the later operating temperature range of such an apparatus is exactly specified during manufacturing.

Arranged between the hot and cold sides, static temperature equilibrium will ensue anyway. In case of homogeneous heat conductivity and wall thickness of the material to be phase-converted there is a temperature distribution. When the layer configuration is designed in such a manner that, corresponding to the expected static temperature distribution in the material the transformation temperatures for the phase transformation are adjusted in the same gradient-like manner, a small, alternating temperature change in the range of the transformation hysteresis suffices to perform the phase transformation in the whole material as simultaneously as possible. The alternating temperature change is excited from outside, e.g. by means of a heat transfer fluid that flows alternately to and fro. The energy of this exciter vibration can be largely recovered in the resonance range, only damping losses (of the flow) have to be compensated. The energy that can be withdrawn as mechanical or electrical work is proportional to heat flow that has to be compensated from outside. If appropriate, this can be supported by a partial flux of a heat transfer fluid that flows from the hot towards the cold side. The energy emitted by this partial flux corresponds largely to the collectible energy. Carnot losses occur in the upper and lower layers and have to be considered for the temperature spread of the transformation hysteresis, yet not for the entire operating temperature range. Between the layers the latent heat stored in the material is utilised which heat remains in the layer system and thus there is a larger amount of this latent heat used for phase transformation than in a homogeneous material with but one transformation temperature.

While energy converters according to the invention that are based on memory-metals (SMS) are preferably suited for slowly vibrating systems (e.g. pumps) due to their large hysteresis (for nitinol 20-30 K), the magneto-caloric effect (MCE) can be exploited to realise faster vibrating systems, e.g. for electric power generation. The latter have hardly any hysteresis which facilitates markedly higher operating frequencies and efficiencies at a comparable heat flow.

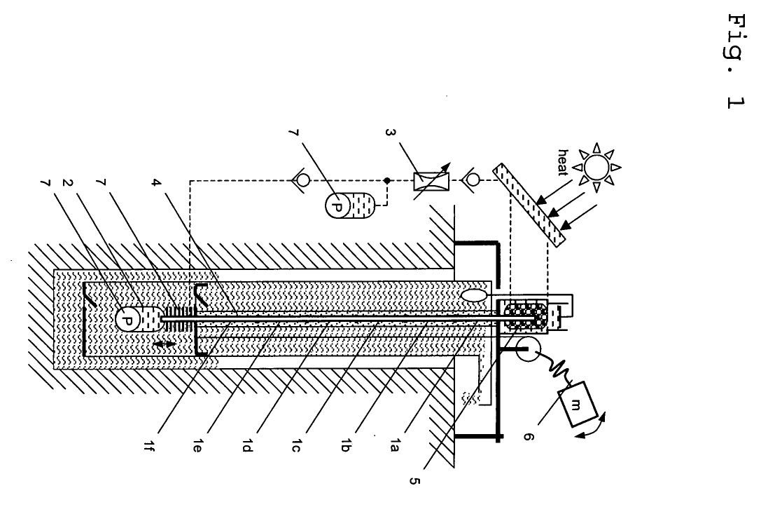

The method according to the invention is explained by means of several practical examples of energy converters realised with the method, illustrated in FIGS. 1-3.

The method according to the invention on the basis of the shape memory effect (SME) can be realised, e.g., in an energy converter based on the memory-metal alloy NiTi (nitinol). The purpose of the method is the recovery of latent heat stored in nitinol material, that cannot be converted into mechanical energy during structural transformation and has to be dissipated in a “normal” Carnot cycle by cooling, in such a manner that it is again available elsewhere in the SME construction element for transformation processes into mechanical energy despite its changed temperature level.

This is achieved by series connection of several SME elements with different transformation temperatures in which a heat transfer fluid is preferably internally moved alternately to and fro.

The basis for this is that by slight changes in the chemical composition of memory-metal alloys their transformation temperatures can be adjusted fairly accurately, for nitinol, e.g., via the nickel content.

Moreover, heat treatment (annealing) of one and the same alloy makes it possible to again influence its transformation temperature and shift it up to 20 K.

Thus, it is possible to manufacture, e.g., tubes “in one casting” whose one end has an up to 20 K higher transformation temperature than at the other end by selecting a higher annealing temperature for one end than for the other end.

By serial connection of several such tubes whose chemical compositions provide for transformation temperatures that are each shifted by ca. 20 K, gradient tubes can be manufactured whose transformation switching point is, e.g., 150° C. at one end, declines over the tube length and at whose other end the transformation switching temperature is, e.g., 15° C. The operating range in this example is firmly between 150° C. and 15° C.

Nickel-titanium alloys with partly slight admixtures of other substances are very well suited for such tubes on account of their good tenacity and corrosion resistance. At a deformation below 2.5% of, e.g., nitinol its fatigue strength can be expected (millions of switching cycles without rupture).

The typical hysteresis of nitinol is in the range from 20-30 Kelvin. It can be reduced by means of an especially fine-grain, aligned crystal lattice structure in metal. Cold forming processes, powder metallurgy and mechanical alloying are opportunities of such optimisation. A hysteresis decreased in such manner also brings about reduction of the pre-deformation forces that are required in the martensitic state (plateau stress) which increases the yield of effective work.

The phase transformation effects (depending on the construction) a translational or rotational movement of tube with considerable power. An optimum power yield can be expected from the metal structure of such as tube when its axial extension is combined with torsion.

During the alternating displacement of heat transfer fluid through the tube there is a heat recovery of the residual heat stored in the metal that could not be withdrawn from the system as mechanical energy.

Thus, the mechanical efficiency markedly exceeds that of known nitinol Carnot machines with but defined transformation temperature and is the higher the finer the transformation switching points are staggered across the entire tube length (if possible linear) and the lower the occurring hysteresis. The maximally possible efficiency depends on the ratio of the total temperature difference to the resulting hysteresis (of the partial segments with the highest hysteresis). Hence, the task at hand is optimising the material in such a manner that the transformation point across the length of the entire tube changes, if, possible linear and evenly and shows largely the same hysteresis in all partial segments which should be as short as possible. The heat transfer fluid does not have to alternately travel the entire displacement length of tube but only (depending on heat capacity and heat transmission) only one part whose length ratio depends, inter alia, from the temperature ratio (A_{f hot}-A_{f cold}) to hysteresis. In case of optimal dimensioning the phase transformation occurs simultaneously at all points of tube.

An apparatus according to the invention based on the shape-memory effect (SME) is, characterised in that one or more tubes 1 of shape-memory metal are connected with each other in such a manner that a heat transfer fluid 2 can be led alternately to and fro while a constant temperature difference is maintained between the tube ends. This can be achieved, e.g., with latent heat accumulators 5 in the reservoirs at the hot and cold sides. Also groundwater has a largely constant temperature.

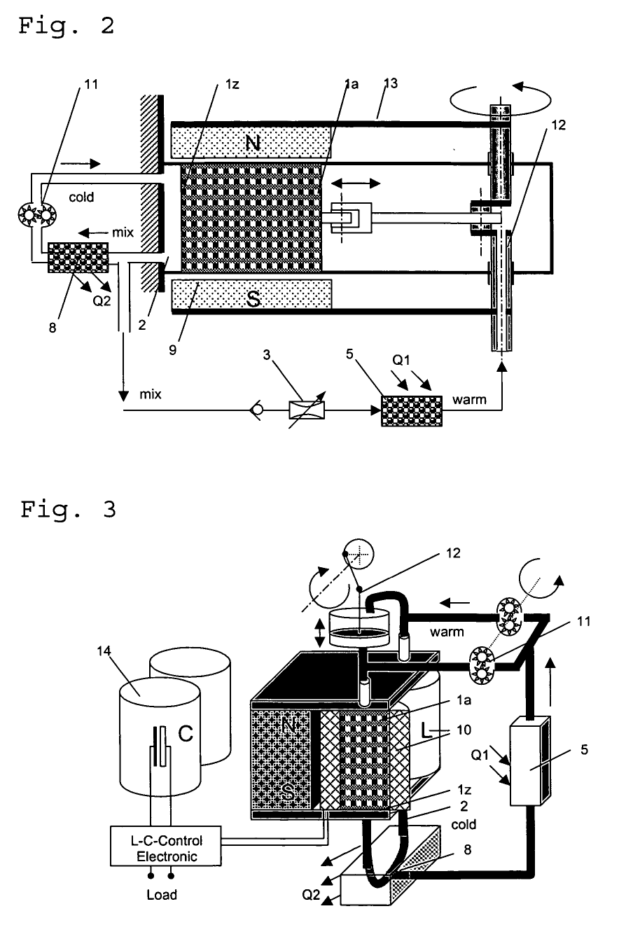

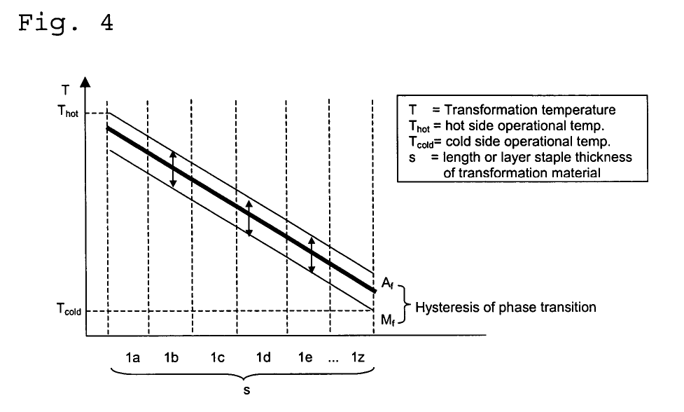

This tube 1 consists of one or more serially-connected partial segments 1a to 1f of metal alloys with shape-memory effect (SME), e.g. nitinol, that have staggered different switching temperatures for phase transformation between austenitic and martensitic metal structures due to different compositions or heat treatment across their length. These switching temperatures are within the temperature spread between hot and cold tube sides with, if possible, the alloys being arranged finely graded with higher transformation temperatures at the hot side and those with lower transformation temperatures at the cold side. (See Diagram FIG. 3)

During the alternating displacement of heat transfer fluids 2 through tube 1 there is a heat recovery of the residual heat amount stored in the SME metal that could not be withdrawn from the system as mechanical energy during phase transformation.

A simultaneously as possible transformation across the entire length in all partial segments 1a to 1f of this tube 1 increases the operating frequency without raising energy consumption and reduces the required volume flows of heat transfer fluid 2.

Also the more thin-walled tube 1, the higher operating frequencies or smaller volume flows of heat transfer fluid are possible, but lesser becomes the amount of transferable power (carrying capacity).

Withdrawal of mechanical work conditions a certain cooling effect in tube 1. The static heat flow in tube 1 (that is created at non-moved heat transfer fluid 2 by heat conductivity of tube 1 or of heat transfer fluid 2) conditions a compensation of withdrawn energy. This can be controlled via different throughput quantities between hot and cold side by recirculating one partial flux through a controllable throttle valve 3 from the cold side to the hot side outside of tube 1 and buffering it in pressure accumulators 7.

An external thermal insulation 4 reduces system losses by radiant emittance and convection.

One potential source of problems is the fatigue strength of the SME tube material 1. When the phase transformation does not progress across the entire tube length in all segments 1a-1f exactly simultaneously (tolerances for switch-over temperature, material composition, wall thickness), which should be the regular case under practical conditions, there is the danger that places where structural transformation commences somewhat later than elsewhere are locally over-expanded and material fatigue (rupture) occurs.

This can be avoided by providing for each tube segment, in particular at least for endangered sections, a mechanical limitation of the deformation displacement of SME tube segments 1a to f in such a manner that any longitudinal extension and torsional extension are limited to the durably appropriate extent in the respective SME tube segments 1a to f. Differences in the spring constant of SME tube segments 1a to f, transformation power and plateau stress that may be conditioned, e.g., by wall thickness tolerances in the different segments 1a to f can be compensated by adjustable tensioning elements (such as springs, equalising masses and displacement limiters) that are connected in parallel across the respective tube segments 1a to f. An initial tension is adjusted.

The temperatures of the hot and cold sides are kept as constant as possible. Well suited latent heat accumulator 5 are in dependence on the temperature spread, e.g. Ba(OH)₂ (melting temperature at 78° C.) or Mg(NO₃)₂.6H₂O (89° C.) or sugar alcohols such as erythriol (119° C.) and d-mannitol (˜165° C.) (hot side), while at the cold side the constant groundwater temperature is used, or ice water (0° C.), Na₂SO₄ (32° C.) or suitable mixtures, e.g. with eutectic saline solutions.

A series connection of the power flow for tube segments 1a to 1f, as shown n FIG. 1, serves, e.g., the execution of water pumps (wells) that are driven by solar radiation or waste heat from cooling or combustion processes.

Also a parallel connection of the power flow at retained series connection of the heat transfer fluid for the individual tube segments is possible in order to change the power-displacement ratio. Such a tube 1 can also be provided with internal parallel tightened wires, capillary tubes or spirals (coil springs) of nitinol if such have the same gradient-like staggered temperature switching points like the partial segments 1a to f in which they are mounted. The wall thickness of these mounting elements should be approximately equal to that of tube 1 in order to prevent local overextensions.

A temporal phase delay is adjusted between the exciter vibration of heat transfer fluid 2 and the effective work vibration of tube 1. This can be preferably done with a mass-spring system 6 vibrating on resonance frequency.

The mass-spring system 6 can be combined with or substituted by further thermodynamic processes, e.g. a Stirling motor. Thus, at the cold side even a temperature lowering or a spreading of the operating temperature (both sides) can be achieved (heat pump principle).

With increasing displacement distance the power in SME transformation decreases, while the power requirement during pumping is constant or exactly the opposite, this is why the yield can be improved, e.g., with a flexure spring mechanism or flywheel masses.

The magneto-caloric effect (MCE) even better suited than the SME for application of the method according to the invention because there are materials available in which phase transformation from ferromagnetic to paramagnetic state progresses at Curie temperature with a lower hysteresis. Hence, already temperature change about 1-3 K are sufficient to attain marked magnetic flow changes. The withdrawable energy per cycle is comparably small which, however, can be compensated by raising the cycle frequency at a good heat flow into the kHz range which in turn improves the magnetic efficiency upon induction of electrical energy in coils.

Thin layers of slightly different ferromagnetic metal alloys are stacked on top of each other in the heat flow axis. This layer block is alternately exposed to a magnetic field. The layer block is preferably closely connected to a coil system and/or alternately exposed to the magnetic sphere of influence of a strong permanent magnet.

The metal gadolinium has a high ferromagnetic saturation magnetisation and ea Curie temperature of 292.8 K (17° C). Gadolinium, alloyed with several semiconductor elements such as Si and Ge, can even amplify the magneto-caloric effect, i.e. the entropy change in the Curie temperature range is higher compared to pure gadolinium which is manifested in much stronger magnetic moment changes during temperature changes. The Si/Ge ratio can be used to well adjust the Curie temperature from 180 K to 340 K. Further suitable materials are manganese-iron alloys with shares of arsenic and phosphor. The As/P ratio can also be used to vary the Curie temperature between −70° C. and +80° C. Also NiMn and Mn₂Sn alloys can be adjusted to Curie temperatures in this range. There are may ferromagnetic manganese alloys with Curie temperatures in the temperature spread 0-150° C. Iron has a Curie temperature of 1043 K. Nickel-copper alloys (Monel) are magnetic depending on their composition up to 25° C. and 100° C. Gadolinium-iron nanocomposites, also with manganese, are very promising.

Operation of a transformer, e.g., in the temperature spread between 80° C. and 20° C. requires arrangement of, e.g., 58 layers with the same thickness on top of each other. The outer layer facing the cold side has a Curie temperature of 21° C. The next layer with minor alloy changes has a Curie temperature of 22° C., the third layer of 23° C. and so on; the 58th layer has a Curie temperature of 79° C.

These layers can preferably be composites with granulates or powders (nanocomposites), formed into tubes, capillary tube-bundles, ring armatures, transformer sheets, heat exchanger plates or supporting structures (such as motor casings or cylinder heads), wire-mesh windings, open-pored metal-foam plates or can be manufactured, e.g., by immersion, sputter or winding processes (with application of dynamic doping methods), with the respective alloy composition being adjusted in each layer exactly to the desired Curie point.

The layers should have a certain permeability level for gaseous or liquid heat transfer fluids.

Thus, these ferromagnetic MCE alloys can be drawn gradient-like over their length into thin capillary tubes and provided with further functional layers (catalyser, conductive, insulation layers or thermoionic effective thin-layer systems) that are subsequently wound into a coil in the form of a compressor piston so that the alloy composition with a higher Curie point is arranged at the hot and the one with a lower Curie point at the cold side, while ensuring that the heat transfer fluid can be alternately moved within the capillaries.

Electrical wiring of an oscillating circuit in which a fast magnetic field change is generated by means of coils induction synchronously to the alternating movement of the heat transfer fluid within the layers at ca. 1 K around the Curie point, is a means of enhancing both energy yield and the frequency of switch-over processes proportionally to the available heat flow—depending on layer thickness, heat exchanger surface and viscosity of the fluid—well into the kHz range. Resonance vibration should be aspired for because it has the lowest losses. A smaller energy portion is needed to excite the oscillating circuit and compensate the losses occurring there. The output magnetic energy largely corresponds to the compensated heat flow. The occurring thermalisation losses, e.g. due to eddy currents and damping losses, are retained within the layer system in the form of heat recovery, so that this heat matters only for the outer layers, however, occurring magnetic moments can be disturbing. If need, electrically insulating grouted nanoparticles can be a remedy.

It can be noted that in a layer system according to the invention, the cold side heats up only slightly upon energy withdrawal while the hot side is cooled like in a conventional heat exchanger-cooler, i.e. limited by die heat conductivities and heat transmissions at and in the layer stack. The major part of the heat flow is “consumed” in the layer stack, i.e. dissipated via magnet flow changes and electrical induction to the atmosphere.

The layer configuration should be such that the Curie temperatures of the outer layers are close to the temperatures of the hot or cold sides and that heat transmission with the outer layers is supported by a swiftly circulating low-viscosity heat transfer fluid with the highest possible heat conductivity. The system is optimised by keeping the temperatures at the hot and cold sides always as constant as possible, matched to the Curie temperatures of the outer layers. This can be achieved by means of a latent heat accumulator. A further optimisation can be performed by suitable dimensioning of layer thicknesses, Curie point grading, excitation frequency (resonance), optimal magnetic and heat flows. Compensation of energy to the centre layers can be improved by suitable duct structures and a heat exchanger fluid.

A magneto-caloric energy converter according to the invention with a high efficiency similar to a disk armature synchronous motor is shown in FIG. 2. Basically, a large variety of heat-driven electrical machines can be executed, such as rotary-current generators and motors, linear drives, shunt-wound machines and also reluctance machines.

The core of the MCE transformer is a stack of thin soft-magnetic alloy layers with a high ferromagnetic saturation magnetisation, the highest possible spontaneous magnetisation and slightly staggered Curie temperatures, e.g. on the basis of gadolinium with variable Si+Ge portions and/or iron-manganese with variable P+As portions with the heat flow being conducted through these layers and the layers with higher Curie temperatures being arranged at the hot side, those with lower Curie temperatures at the cold side, as shown in FIG. 4.

In the practical example in FIG. 2 the MCE layer system 1a-1z according to the invention in the form of an open-pored fine metal foam forms a displacer piston that is moved via a crankshaft 12 and through which the heat transfer fluid (e.g. water) flows alternately to and fro between the cold side (2) and the hot side 5. After the pores of the displacer piston have been filled with water from the cold side 2 its metal alloy 1a-1z is available in ferromagnetic form slightly below the Curie temperature. The disk armature 13 connected to the crankshaft 12 is fitted with a strong permanent magnets (9) that are attracted by the layer system 1a-1z in ferromagnetic state and facilitate acceleration work (torque) at the crankshaft 12. An NdFeB permanent magnet with Ø32 mm×7 mm, e.g., achieves lifting power of at least up to 350 N, although the layer system 1a-1z near the Curie temperature enables only markedly lower magnetic moments. Simultaneously, the movement of the crankshaft presses the displacer piston towards the hot side. Hot water flows into the pores and presses the water column towards the cold side, by the Curie temperature in the layers is exceeded as suddenly as possible and the layer system 1a-1z loses its magnetic moment. Now the permanent magnets 9 can slightly detach themselves from the layer system due to the momentum of the disk armature rotor 13. The attraction was higher than the break-loose force. Along the periphery of such a disk armature synchronous motor several such layer blocks 1a-1z are arranged so that the magnets 9 are now attracted by the next layer block and thus a continuous rotary movement is generated.

The layers 1a-1z are porous. They can be open-pored metal foam plates that are stacked on top of each other but also flow-transmitting wire-mesh windings, tightly pressed wire nettings or thin, perforated sheets fitted with capillary bores.

Wire-mesh windings could provide advantages for manufacturing, e.g. as a basic mesh form similar to a fine mesh wire fence with adjacent individual wires that are slightly distinguished by their respective Curie temperatures. Wire-mesh constructions have an advantage over metal foam in that the magnetic flow density in the MCE material can rise higher because the wires can be better aligned at the outside magnetic field, a very even metal structure thickness (wire diameter) can be adjusted and in addition the wire surface is better suited for applying, prior to weaving, functional layers for corrosion protection, heat transmission or even a thermionic utilisation of the heat flow. Heat transmission can be enhanced by ion implantation onto the metal surfaces.

The flow permeability should be dimensioned in such a manner that a local heating is achieved per stroke in each point of the layer stack 1a-1z by a few Kelvin so that the Curie temperature in each point is just exceeded and fallen short of. Also influence of the magnetic field 9 that increases upon approximation conditions a temperature rise in the layers (without water by up to 20 K) that should be very swiftly dissipated from the metal by sufficient “ambiance water”.

The attraction of the magnet 9 to the ferromagnetic layers 1a-1z depends on the material volume (both of the permanent magnet and the ferromagnetic material). Because of the relatively slow heat spreading speed (limited heat conductivity) it is thus obvious that the process functions better with many thin layers with gradient-like narrowly staggered Curie points than with only one or a few thick layers.

The cold side is cooled with a heat exchanger 8. When there are many layers to cover a broad temperature spread or the pressure drop in the layers is too high in relation to their temperature conductivity, compensation of the collectible energy that is “consumed” in the layer stack 1a-1z via a heat transfer fluid (liquid or gas) and appropriate ducts to the internal layers receives an increasing significance because otherwise the internal, cold layers are unable to reach the transformation temperature in the same time interval as the outer layer at the hot side 1a or there may be a disturbing temporal delay.

Hence, a small partial flux of heat transfer fluid (e.g. water) is returned via a throttle valve 3 from the cold side to the hot side from outside. The controllable throttle valve 3 can be used to adjust the thermal compensation (according to the withdrawal rate of collectible energy). In the present example, the residual heat Q2 that is to be discharged at the cold side with heat exchanger 8 is pumped via a dosing pump 11 through heat exchanger 8, while a partial flux for recirculation to the hot side is previously separated at mixing temperature to re-absorb new heat Q1 through heat exchanger 5.

The heat transfer fluid is preferably a non-reactive fluid or a gas with high heat storage capacity, heat conductivity and lo viscosity, e.g. water or helium. The latter may also be pre-compressed. When a gas is used, the method according to the invention may also be coupled with the Stirling process. The gas may also be mixed with substances whose dew point is within the operating temperature upon adjusted pre-compression pressure, e.g. refrigerants (Rankine or Kalina process). Thus the performance density in relation to the piston capacity increases but a swift temperature change in the layers 1a-1z is dampened. This can, however, be advantageously used to reduce the layer number or enlarge the layer thickness of a certain Curie temperature (dew point). Then, preferably liquid condensate is returned to the hot side via the partial flux and evaporated there during a work stroke. The working point of the apparatus can be adjusted via the pre-compression pressure. Corrosion and cavitation in the layer system have to be prevented.

Usage of a latent heat accumulator material and heat exchangers 5 will adjust a constant heat flow and an even operating state (e.g. constant rotational speed).

A further form of execution of a magneto-caloric energy converter is shown in FIG. 3. There the layer system 1a-1z according to the invention is wrapped by a coil 10 and in the present example firmly arranged in pairs a magnetic field 9. The heat transfer fluid is alternately moved to and fro via an externally driven crank mechanism 12 with piston between the two layer blocks so that one layer block becomes ferromagnetic and at the same time the other layer block paramagnetic. The magnetic flow of the permanent magnet 9 thus changes between the two layer blocks. The magnetic field changes condition an electrical induction in the coils 10. Electrical load withdrawal is optimised by means of an oscillating circuit with capacitors 14 (if possible with resonance frequency). Compensation of the partial flux of heat transfer fluid is performed with dosing pumps 11 in this example. The pumps have the same function as the throttle valve 3 in FIGS. 1 and 2.

Also further very thin layers of electrical insulating material or conductor loops may be arranged between the layers 1a-1z. The thin metal layers 1a-1z may simultaneously take on the electrical function of a plate-type capacitor and the induction of eddy currents can be purposefully reduced and limited to the layer levels. The heat conductivity of the electrical insulating layers and the surface of this boundary level (microroughness/porosity) should be as high as possible. The layer thickness of this insulation is preferably in the nanometre range.

When hot gases are available at the hot side, as is the case upon application of the layer system according to the invention in combustion (e.g. Otto, Diesel motors) or high-compression Stirling motors, then the outer layer of the layer system according to the invention at the hot side can preferably be equipped with thermoionic active thin layer system. Apart from a corrosion protection function (required e.g. for gadolinium alloys in the presence of water steam) such layers which are only a few micro- or nanometres thin assume the function of a “thermal diode” to directly abstract electrical power with an efficiency up to 20% from the short-time high temperature differences between gas and metal.

In combustion motors, a catalyser-coated layer system (1a-1z) according to the invention that is flown through upon each gas inlet and outlet can, on the one hand, considerably reduce heat losses via exhaust gas and, on the other, abstract collectible energy from waste heat and thus markedly enhance overall efficiency, in particular in combination with the Stirling principle.

The advantages of the method according to the invention are that the maximal possible efficiency is not subject to the restrictions of cyclic gas processes and apparatuses with high energy yields and small sizes become feasible. The method opens fort the first time the opportunity of using sources of energy such as hot water for an economic generation of electric power or motor power by considerably increasing the energy content of the working medium (metal in the place of gas) and the heat transmission (water-metal in the place of metal-gas) for a high heat flow in contrast to conventional gas-based cyclic processes. Thus, machine sizes can be reduced by a factor of up to 3000 even in case of relatively small temperature differences, as compared to the energy yield of, e.g., a low-temperature Stirling motor. Heating of the cold side can be largely suppressed. These Carnot-typical heat losses are essentially restricted to the material-specific temperature spread of the hysteresis in the layer system according to the invention. Hence, mechanical efficiency increases the lower the hysteresis temperature difference is in relation to the overall temperature difference (i.e. presupposing a linear gradient tube or layer system whose range of transformation temperatures covers the entire temperature spread.)

An energy converter according to the invention is capable of transforming solar energy (heat) and waste heat from cooling processes already at small temperature differences to the ambiance into mechanical energy. In addition, it can be advantageously combined with conventional thermodynamic processes, e.g. applied as a heat exchanger with catalyser function in combustion motors, heat pumps or layer-type heat accumulators or chemical plants.

The method can be scaled. Beside applications in power stations, waste incinerators, solar and geothermal plants the method is also suited, inter alia, in miniaturised form e.g. as a chip cooler to generate electric power from the waste heat of electronic components. It can be used, e.g., to extend the operating time of notebook batteries.

The invention is distinguished from previously known methods for heat-power transformation by a higher efficiency at optimal material exploitation through utilisation of a phase transformation process with change of entropy and without change of the state of aggregation. Due to a gradient-like progress of the phase transformation temperature along the axis of static heat flow, a thermal vibration of the heat flow with a temperature difference in the range of the phase transformation hysteresis that is generated with a low level of energy input suffices to perform the phase transformation in the entire material nearly simultaneously. Energy that cannot be converted into collectible energy remains largely in the system after heat recovery and does not have to be dissipated as Carnot loss as in other thermodynamic processes.

The method is suitable for efficiency enhancement in a fixed pre-specified temperature spread. Exceeding or a shift of the temperature spread conditions again an efficiency deterioration (latent heat losses lose their impact), in contrast to other thermodynamic processes.

An apparatus according to the invention based on the SME (form-shape memory metal effect) is distinguished from other nitinol power machines in that it consists of serially connected tube segments of slightly different SME metal alloys whose partial segments with higher transformation temperatures are arranged at the hot side and those with lower transformation temperatures at the cold side and in that a heat transfer fluid is led alternately to and fro between the hot and the cold sides. A regulable partial flux of heat transfer fluid is returned from the cold side to the hot side outside of the nitinol tube.

An apparatus according to the invention based on the MCE (magneto-caloric effect) is distinguished from other magneto-caloric generators in that several layers of slightly different ferromagnetic metal alloys are stacked on top of each other towards the heat flow, whose partial segments with higher Curie temperatures are arranged at the hot side and those with lower Curie temperatures at the cold side. This layer stack is alternately slightly heated up and cooled-off, while in addition a static heat flow is maintained between the cold and the hot side in order to compensate heat respectively into the layer interiors or from the hot to the cold side. Magnetic flow changes that are conditioned by magnetisation upon undershooting of the Curie temperature are used for a withdrawal of electrical energy by induction. In order to achieve a more even compensation of heat within the layers, the latter may be executed porous or provided with ducts to lead a heat transfer fluid alternately to and fro between the hot and the cold sides. Subsequently, a regulable partial flux of heat transfer fluid is returned from the cold side to the hot side outside of the MCE layer stack.

### REFERENCE CHARACTERS

1. Segmented tube of shape-memory metal
1a-1f. Partial tube segments of shape-memory metal with evenly staggered phase transformation temperature
1a. The first segment at the hot side has the highest phase transformation temperature of all segments
1f. The first segment at the cold side has the lowest phase transformation temperature of all segments
1a-1z. MCE layer system in the form of an open-pored displacer piston with evenly staggered phase transformation temperature
2. Heat transfer fluid
3. Controllable throttle valve
4. External thermal insulation
5. Latent heat accumulator
6. Mass-spring system vibrating at resonance frequency
7. Pressure accumulator
8. Heat exchanger at the cold side
9. Permanent magnet
10. Coil
11. Dosing pumps
12. Crankshaft
13. Disk armature rotor
14. Capacitors in an oscillating electrical circuit

1. Method for efficiency enhancement in the transformation of heat into mechanical or electrical energy under exploitation of thermally induced phase transitions with entropy change without state of aggregation changes, wherein a temperature difference is maintained at both sides of a material provided for phase transformation, and a gradient-like shift of the transformation temperature for a specified operating temperature range is firmly adjusted in this material provided for phase transformation along the axis of the heat flow, and the partial segments with higher transformation temperatures are arranged linear or finely staggered at the hot side and those with lower transformation temperatures at the cold side, in order to achieve a thermal series connection of these partial segments by thermal vibration in the range of the material-conditioned hysteresis and an alternately changing phase transformation, if possible, simultaneously in all partial segments, and there is a heat recovery of non-used latent heat between the individual segments.

2. Method according to claim 1, wherein the phase transformation from martensitic to austenitic metal lattice structure in some metal alloys with a distinctive form change, the shape-memory effect (SME), is utilised.

3. Method according to claim 1, wherein the phase transformation from ferromagnetic to paramagnetic state in some metal alloys with a distinctive magneto-caloric effect (MCE) is utilised.

4. Method according to claim 1 wherein the compensation of heat is performed proportionally to the withdrawn collectible energy by means of a regulable partial flux of a liquid or gaseous heat transfer fluid that superimposes thermal vibration and flows from the hot to the cold side within one or several ducts in the material provided for phase transformation, due to which more heat transfer fluid flows through the material from the hot side to the cold side in the course of one working cycle than vice versa.

5. Method according to claim 4, wherein any recirculation of the partial flux from the cold side to the hot side of the material provided for phase transformation is performed as a recirculation outside of this material.

6. Apparatus for application of the method, wherein a tube (1) with serially lined up partial segments (1a to 1f) of metal alloys with shape-memory effect (SME), e.g. nitinol, that have different switching temperatures staggered across their length for the phase transformation between austenitic and martensitic metal structures due to different compositions or heat treatments, is coupled with a mobile mechanism that predetermines the displacement of alternately defined length or axial angular change of this tube (1) (main vibration or working stroke) and that moves a defined quantity of a heat transfer fluid (2), such as water or oil, to and fro alternately through tube (1) by means of a piston, pressure or level differences (exciter vibration).

7. Apparatus according to claim 6, wherein the mechanism for conveying the alternately vibrating heat transfer fluids (exciter vibration) is connected via a mass-spring system (6) to the alternately vibrating working stroke (main vibration) of tube (1) in such a manner that a temporal delay, i.e. a phase shift occurs between main and exciter vibration, while their frequencies are equal.

8. Apparatus according to claim 7, wherein the mass-spring vibration is performed in the resonance range.

9. Apparatus according to claim 6, wherein a mechanical limitation of the deformation displacement is provided for individual tube segments (1a-1f) by means of displacement limiters, so that the potential longitudinal extension and also torsional extensions can be limited to the durably appropriate extent for the respective SME tube segments (1a-1f).

10. Apparatus according to claim 6, wherein differences in the spring constant of SME tube segments (1a-1f), transformation power and plateau stress are compensated by means of adjustable tensioning elements, such as springs and equalising masses, that are connected in parallel to the respective tube segments (1a-1f), by adjusting an initial tension at each tube segment.

11. Apparatus according to claim 6, wherein parallel tightened wires, capillary tubes or spirals (coil springs) are arranged in tube (1) filled with heat transfer fluid, that are of the same SME material as the tube (1) proper, or that several SME tubes (1) filled with heat transfer fluid (2) are switched in parallel to each other.

12. Apparatus for application of the method according to claim 6, comprising a stack of layers (1a-1z) of soft-magnetic alloys with a high ferromagnetic saturation magnetisation, the highest possible level of spontaneous magnetisation and each with a slightly staggered Curie temperature in the intended operating temperature range, e.g. on the basis of gadolinium with variable Si+Ge portions and/or iron-manganese with variable P+As portions, in which the heat flow is through these layers and the layers (1a, 1b, . . . ) with higher Curie temperatures being arranged at the hot side, those with lower Curie temperatures (. . . , 1y, 1z) at the cold side within the magnetic sphere of influence of a coil system (10) and are alternately or also steadily exposed to strong magnetic field (to 9), preferably to a permanent magnet (9).

13. Layers of the apparatus from claim 12, wherein such are formed into tubes, capillary tube bundles, ring armatures, displacement pistons, transformer sheets or supporting structures (such as motor casings or cylinder heads) or are attached to such or are executed as foam, wire-mesh or fine-fabric constructions.

14. Layers according to claim 12, wherein they have internal pores and ducts that have a defined permeability towards the heat flow for a liquid or gaseous heat transfer fluid.

15. Apparatus according to claim 6, wherein further functional layers are arranged on the surface material provided for phase transformation in the layers (1a or 1z) with layer thicknesses in the micro-or nanometre range, such catalyser, corrosion protection or thermionic acting layers (thermal diode), or that ions gave been implanted into the surface.

16. Apparatus according to claim 6, wherein foam, wire-mesh or fine fabric constructions of non-magnetic materials serve as carrier for the soft-magnetic alloys according to 12 provided for phase transformation, that are applied as in the form of powder or granulate or are embedded as nanocomposites.

17. Apparatus according to claim 6, wherein further very thin layers of electrical insulating material are arranged between the layers (1a-1z) or on the surface of the porous or fibrous metal structure of the layers (1a-1z) and that the metallic layers (1a-1z) are electrically wired into a plate-type capacitor.

18. Apparatus according to claim 6, wherein further thin layers of electrical insulating and electrical conductive material are arranged between the layers (1a-1z) and that these layer formations in the form of capillary tubes or narrow strips are arranged like conductor loops with the electrical function of an induction coil.
